(19) United States
(12) Patent Application Publication
(10) Pub. No.: US 2009/0099489 A1
(43) Pub. Date: Apr. 16, 2009

(54) MASSAGER

(75) Inventors: Takayoshi Tanizawa, Higashiomi-shi (JP); Masamichi Miyaguchi, Hikone-shi (JP); Fumihiro Nishio, Hikone-shi (JP); Takeo Iijima, Hikone-shi (JP); Daisuke Tsukada, Hikone-shi (JP); Yuichi Nishibori, Hikone-shi (JP); Satoshi Kajiyama, Hikone-shi (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 12/282,243

(22) PCT Filed: Mar. 27, 2007
(86) PCT No.: PCT/JP2007/056282

§ 371 Date: Sep. 9, 2008

(30) Foreign Application Priority Data
Mar. 28, 2006 (JP) 2006-089577

(51) Int. Cl. A61H 7/00

(52) U.S. Cl. 601/84; 601/134; 601/9

(57) ABSTRACT

In a chair massager, a stretching operation is performed with utilizing airbags which is expanded and shrunk, effectively. Airbags 3a, 3b, 4a, 4b, 5a and 5b which perform air-massage by expansion and shrinkage are disposed on a shoulder portion 3 and a lumbar portion 4 of a backrest 2, and a seat 5 of a main body 1 of the massager. Arm airbags 6a and 6b which perform air-massage by expansion and shrinkage are disposed on armrests 6 at both sides of the seat 5. In the stretching operation, for example, a shoulder airbag 3b on the shoulder portion 3 is expanded and shrunk in a state that an arm airbag 6a on one armrest 6 is expanded to hold an arm of the user 200. Thereby, the balance of a human body of the user 200 is broken down so that high stretch effect can be obtained.

### TECHNICAL FIELD

The present invention relates to a massager which performs air-massage by expanding and shrinking airbags, and especially relates to one which can perform stretch by effectively utilizing the airbags which are expanded and shrunk.

### BACKGROUND ART

In a chair type massager comprising mechanical treatment elements provided in a backrest thereof, it is configured to make massage effects to a user who sits on the massager by displacing the treatment elements in projecting direction from the backrest, in up and down direction and in left and right direction. As for such a massager, there is a thing which has airbags located at positions other than an area to be treated by the treatment elements in the backrest. In the massager having the airbags, it is possible to press a body part other than a treatment area of the treatment elements by expanding and shrinking the airbags, and thus, a massage can be put for a user from head to foot.

By the way, as shown in Japanese Laid-Open Patent Publication No. 2004-41383, it is proposed that a massager enables to perform stretching to feet of the user by providing airbags in a leg-rest and synchronizing the expansion and shrinkage of the airbags with rising up and falling down of the leg-rest. However, in such massager, since upper body of the user cannot be held on the massager, it is impossible to perform stretching of the upper body of the user.

### DISCLOSURE OF INVENTION

The present invention is perceived to solve the above mentioned problems, and aimed to provide a massager that can perform the stretching to the user effectively by utilizing the airbags which perform air-massage by expansion and shrinkage.

A massager in accordance with an aspect of the present invention is a chair type massager comprising a backrest, a seat and armrests which are disposed at both sides of the seat, airbags which perform air-massage by expansion and shrinkage provided at both sides of one or more portions among a shoulder portion or a lumbar portion of the backrest and the seat, and arm airbags which perform air-massage by expansion and shrinkage respectively provided on left and right armrests, wherein stretching operation is performed by expanding and shrinking one or both of the airbags provided at both sides of one or more portions among the shoulder portion or the lumbar portion of the backrest and the seat, or alternately expanding and shrinking the airbags provided at both sides in a state that an arm of the user is held on the armrest by expanding the arm airbag provided on at least one of the armrests.

### BRIEF DESCRIPTION OF DRAWINGS

FIG. 1 is a side view showing an example of a massager in accordance with an embodiment of the present invention.

FIG. 2 is a front view of the above massager.

FIG. 3 is a block diagram showing a configuration of an air pipe arrangement of the above massager.

FIG. 4 is a block diagram showing a configuration of a control circuit of the above massager.

FIG. 5 is a plain view showing a stretching operation in accordance with a first practical example of the above massager.

FIG. 6 is a plan view showing a modification of the above stretching operation.

FIG. 7A is a plain view showing a modification of the above stretching operation, and FIG. 7B is a plain view showing a state where a shoulder airbag in counter side is expanded from the state shown in FIG. 7A.

FIG. 8 is a front view showing a modification of the above stretching operation.

FIG. 9 is a plain view showing a stretching operation in accordance with a second practical example of the above massager.

FIG. 10 is a plain view showing a modification of the above stretching operation.

FIG. 11A is a plain view showing a modification of the above stretching operation, and FIG. 11B is a plain view showing a state where a shoulder airbag in counter side is expanded from the state shown in FIG. 11A.

FIG. 12A is a front view showing a modification of the above stretching operation, and FIG. 12B is a front view showing a state where a seat airbag in counter side is expanded from the state shown in FIG. 12A.

FIG. 13 is a plain view showing a stretching operation in accordance with a third practical example of the above massager.

FIG. 14 is a plain view showing a modification of the above stretching operation.

FIG. 15A is a plain view showing a modification of the above stretching operation, and FIG. 15B is a plain view showing a state where a shoulder airbag in counter side is expanded from the state shown in FIG. 15A.

FIG. 16 is a plain view showing a stretching operation in accordance with a fourth practical example of the above massager.

FIG. 17 is a plain view showing a modification of the above stretching operation.

FIG. 18A is a plain view showing a modification of the above stretching operation, and FIG. 18B is a plain view showing a state where a shoulder airbag in counter side is expanded from the state shown in FIG. 18A.

FIG. 19A is a front view showing a modification of the above stretching operation, and FIG. 19B is a front view showing a state where a seat airbag in counter side is expanded from the state shown in FIG. 19A.

FIG. 20A is a side view showing a stretching operation in accordance with a fifth practical example of the above massager, and

FIG. 20B is a side view showing a state where a backrest is erected from the state shown in FIG. 20A.

FIG. 21 is a time chart showing motions of each elements of the massager in the above stretching operation.

FIG. 22A is a side view showing a stretching operation in accordance with a sixth practical example of the above massager, and

FIG. 22B is a side view showing a state where a leg-rest is felled down from the state shown in FIG. 22A.

FIG. 23 is a time chart showing motions of each elements of the massager in the above stretching operation.

### BEST MODE FOR CARRYING OUT THE INVENTION

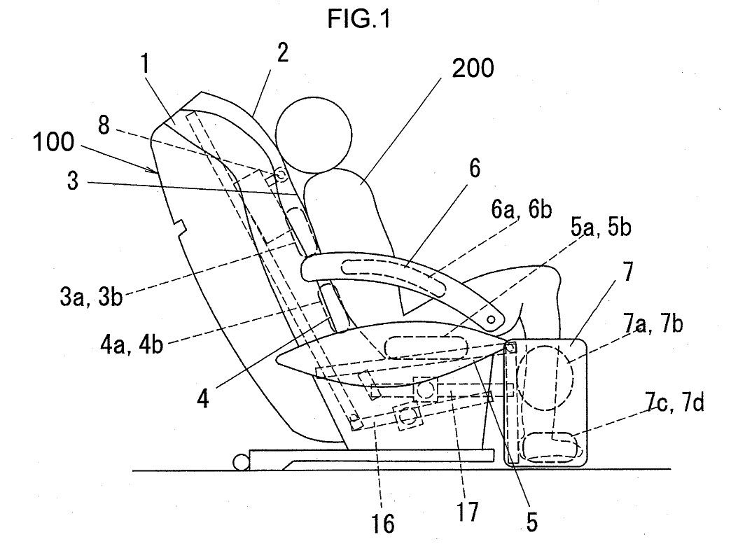

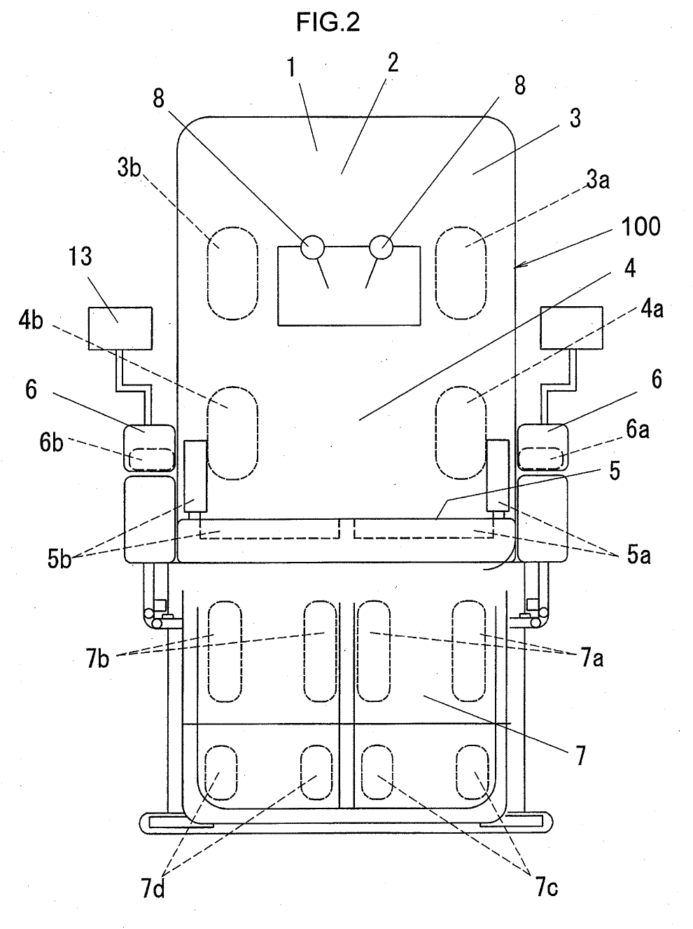

A massager in accordance with an embodiment of the present invention is described in detail with reference to drawing. FIG. 1 and FIG. 2 show a configuration of the massager in accordance with this embodiment. The massager 100 is a chair type one on which a user 200 can sit. A main body 1 of the massager comprises a backrest 2 which has a shoulder portion 3 and a lumbar portion 4, a seat 5 which serves as a portion on which the user 200 sits, armrests 6 which are disposed at both sides of the seat 5, and a leg-rest 7 to which portions of legs below the knees of the user are disposed. The backrest 2 is coupled to the seat 5 through a backrest reclining mechanism 16. The armrest 6 is configured that a portion from elbow to finger-tip of the arm of the user 200 who sits on the seat can be clamped thereon. The leg-rest 7 is coupled to a front portion of the seat 5 through the leg-rest reclining mechanism 17. Treatment elements 8 are movably built-in the backrest 2. The massager 100 is configured to perform massage to the user by applying external stimulus such as massaging, pressing and so on by moving the treatment elements 8.

Shoulder airbags 3a and 3b are disposed substantially symmetrical in the widthwise direction on the shoulder portion 3 of the backrest 2. Lumbar airbags 4a and 4b are disposed substantially symmetrical in the widthwise direction on the lumbar portion 4 of the backrest 2. Seat airbags 5a and 5b are respectively disposed on the seat 5 corresponding to left and right buttocks of the user 200. In addition, arm airbags 6a and 6b are respectively disposed on the armrests 6 disposed at left and right sides of the seat 5. Leg airbags 7a and 7b are respectively disposed in the leg-rest 7 corresponding to left and right calves of the user 200. In addition, foot airbags 7c and 7d are respectively disposed in the leg-rest 7 corresponding to left and right feet of the user 200.

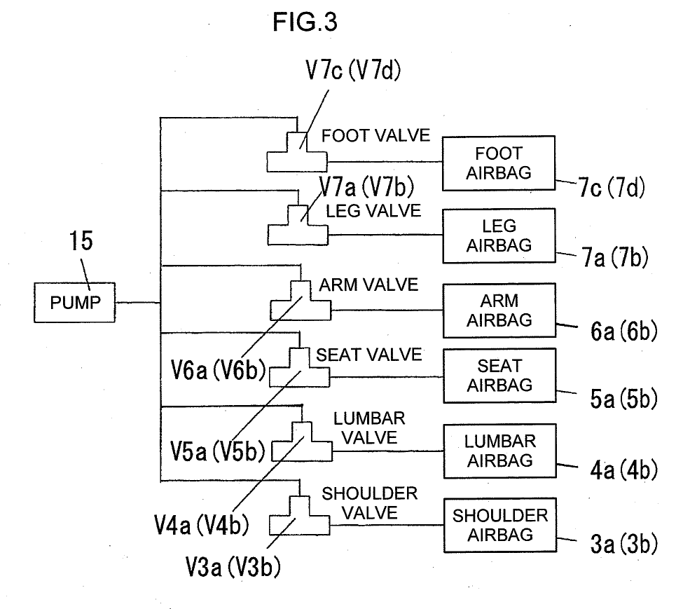

FIG. 3 shows a configuration of an air pipe arrangement to operate each airbags 3a, 3b, 4a, 4b, 5a, 5b, 6a, 6b, 7a, 7b, 7c, and 7d of the massager 100. As show in the figure, the massager 100 has a pump 15 which generates high-pressure air for operating the airbags 3a to 7d. The airbags 3a, 3b, 4a, 4b, 5a, 5b, 6a, 6b, 7a, 7b, 7c, and 7d are connected to the pump 15 through solenoid valves V3a, V3b, V4a, V4b, V5a, V5b, V6a, V6b, V7a, V7b, V7c, and V7d each. The solenoid valves V3a to V7d each are configured to open and cutoff pressure supplying systems from the pump 15 to the airbags 3a to 7d, so as to supply the high-pressure air generated by the pump 15 to the airbags 3a to 7d and to exhaust the air in the airbags 3a to 7d. The airbags 3a to 7d are expanded by supplying air by the pump 15. The seat airbags 5a and 5b on the seat 5 each are formed in a shape of substantially L-character so that each of them partially erects upward as shown in FIG. 2 which is an anterior view. The massager 100 is configured that hip of the user 200 can be held by expanding the seat airbags 5a and 5b. In addition, the massager 100 is configured that shoulder of the user 200 can be held by expanding the shoulder airbags 3a and 3b. Moreover, the massager 100 is configured that lumbar of the user 200 can be held by expanding the lumbar airbags 4a and 4b. Besides, the configuration of the air pipe arrangement for expanding and shrinking each airbags 3a to 7d independently can be designed in various ways.

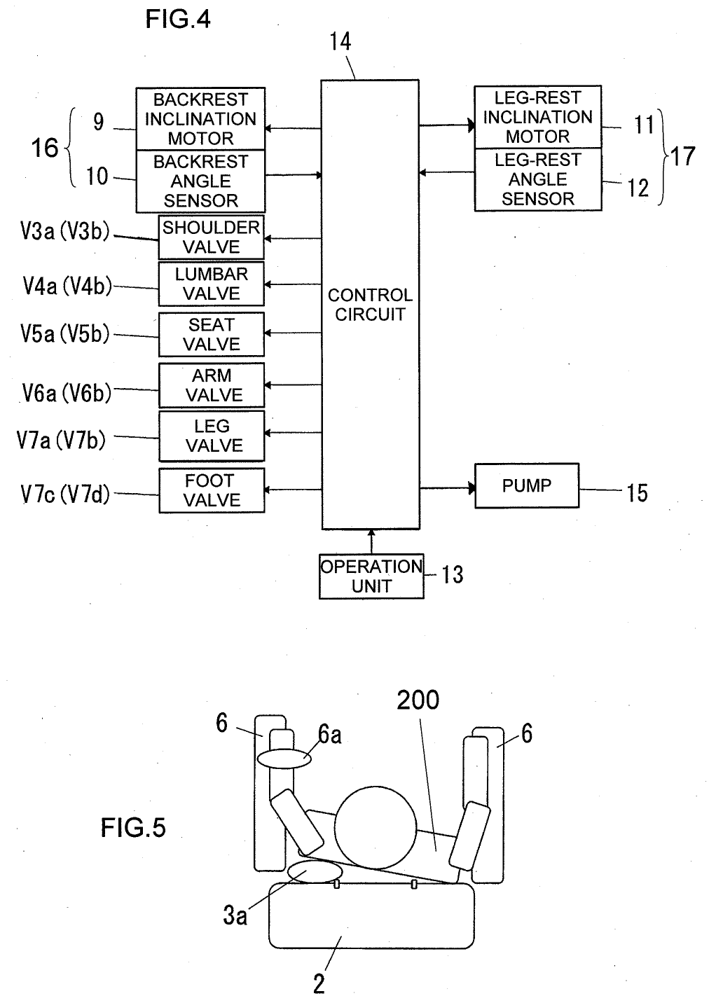

FIG. 4 shows a configuration of a control circuit of the massager 100. The massager 100 has an operation unit 13 which is operated by the user 200 and a control circuit 14 which controls each department of the massager 100 such as the solenoid valves V3a to V7d and the pump 15 corresponding to the operation given to the operation unit 13. The solenoid valves V3a to V7d and the pump 15 operate with control signals transmitted from the control circuit 14 so as to expand and shrink the airbags 3a to 7d independently. Besides, one of the left and right airbags 3a, 3b . . . , is illustrated in FIG. 3 and FIG. 4 for the purpose to simplify the description, and the other is omitted from the illustration. The same goes for the solenoid valves V3a, V3b . . . , V7d.

The backrest reclining mechanism 16 comprises a backrest inclining motor 9 which is controlled by the control circuit 14 and a backrest angle sensor 10 which detects an angle of the backrest 2. The leg-rest reclining mechanism 17 comprises a leg-rest inclining motor 11 which is controlled by the control circuit 14 and a leg-rest angle sensor 12 which detects an angle of the leg-rest 7. For example, when the operation unit 13 is operated by the user 200, the control circuit 14 generates control signals for driving the backrest inclining motor 9 and the leg-rest inclining motor 11 corresponding to the angles of the backrest 2 and the leg-rest 7 which are detected by the backrest angle sensor 10 and the leg-rest angle sensor 12. Then, the backrest reclining mechanism 16 sets the backrest 2 in a desired reclining angle due to the backrest inclining motor 9 is driven on the basis of the control signal from the control circuit 14. In addition, the leg-rest reclining mechanism 17 sets the leg-rest 7 in a desired reclining angle due to the leg-rest inclining motor 11 is driven on the basis of the control signal from the control circuit 14.

The massager 100 is configured to perform various stretching operations by expanding and shrinking the airbags 3a to 7d. Such various stretching operations are performed on the basis of the control by the control circuit 14 when an operation is instructed by the operation unit 13. The control circuit 14 is previously installed programs for performing various stretching operations with controlling the airbags 3a to 7d. Each stretching operations are described as practical examples of the operations of the airbags 3a to 7d, below.

### FIRST PRACTICAL EXAMPLE

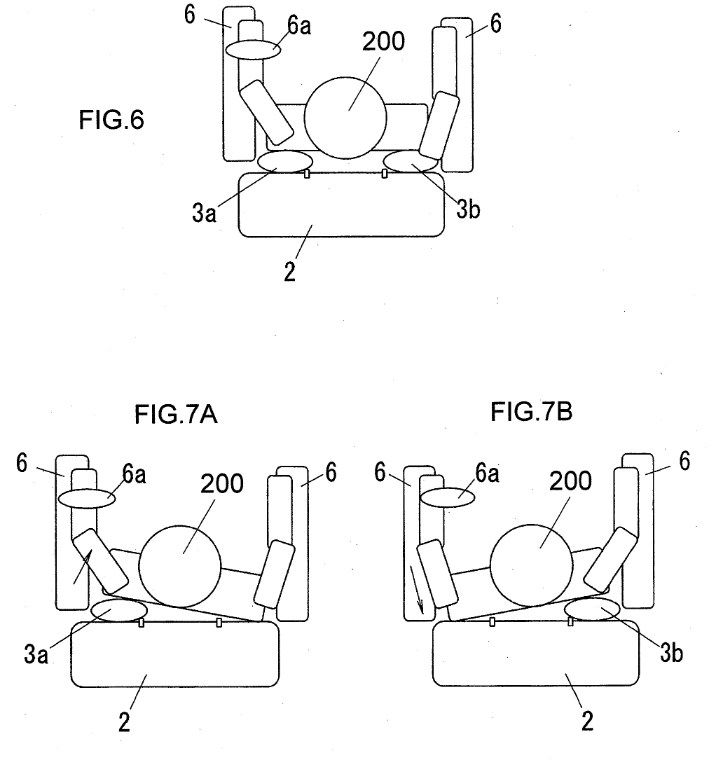

Motion of the massager 100 in a stretching operation in accordance with a first practical example is described with reference to FIGS. 5 to 8. Besides, in the FIGS. 5 to 23, only the airbags to be expanded among the airbags 3a to 7d are illustrated for the purpose of the simplification. In the first practical example, a stretching operation is performed by expanding and stretching one or both of the left and right airbags 3a to 5b on the shoulder portion 3 or the lumbar portion 4 or the seat 5 in a state that an arm of the user 200 is held on the armrest 6 by expanding the arm airbag 6a or the arm airbag 6b. As shown in FIG. 5, for example, the massager 100 holds left arm of the user 200 by expanding the arm airbag 6a disposed on the left armrest 6 of the main body 1 of the massager. Then, the left shoulder airbag 3a disposed on the shoulder portion 3 is expanded so as to break down the right-and-left balance of the human body of the user 200. Thereby, back of the user 200 is twisted so that stretching effect can be obtained. In this case, it is possible to perform the stretching operation by expanding the left lumbar airbag 4a disposed on the lumbar portion 4. Alternatively, as shown in FIG. 6, for example, the massager 100 performs the stretching operation by pushing the back of the user 200 by expanding both of the left and right shoulder airbags 3a and 3b in a state that the left arm of the user 200 is held on the left armrest 6 by expanding the arm airbag 6a of the left armrest 6. In this case, it is possible to perform the stretching operation by pressing the lumbar of the user 200 with expanding the left and right airbags 4a and 4b.

Furthermore, in the first practical example, the massager 100 may perform the stretching operation by alternately expanding and shrinking both of the left and right airbags 3a to 5b on the shoulder portion 3 or the lumber portion 4 or the seat 5 in a state that an arm of the user 200 is held on the armrest 6. As shown in FIG. 7A and FIG. 7B, for example, the massager 100 continuously performs the stretching that alternately twist the back by breaking down the left-and-right balance of the human body of the user 200 while alternately expanding and shrinking the left and right shoulder airbags 3a and 3b in a state that the left arm of the user 200 is held on the armrest 6 by expanding the arm airbag 6a in the left armrest 6. In this case, it is possible to expand and shrink the left and right lumbar airbags 4a and 4b alternately. By alternately expanding and shrinking the shoulder airbags 3a and 3b or the lumbar airbags 4a and 4b, the stretching effect becomes much higher.

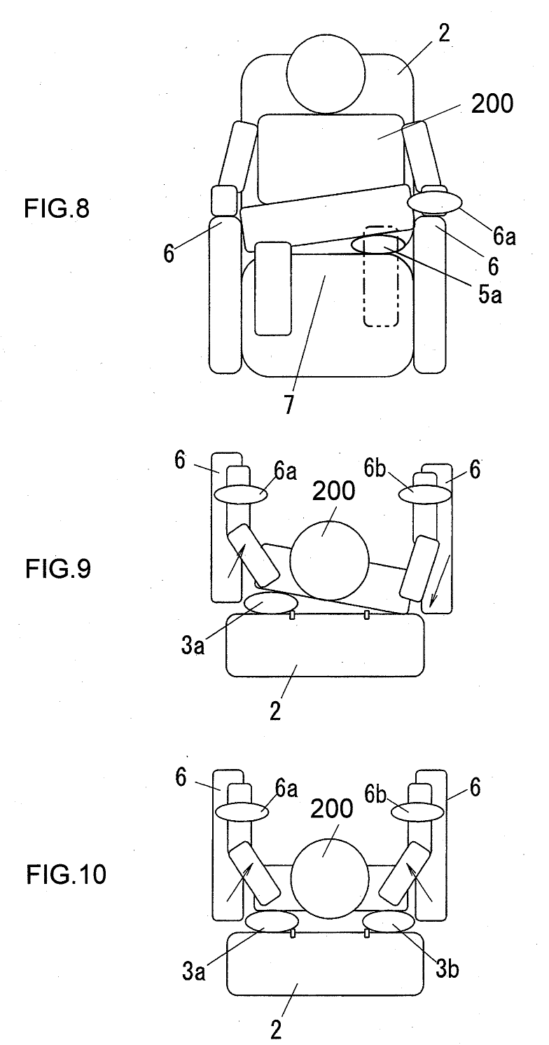

Furthermore, as shown in FIG. 8, for example, the massager 100 expands the left seat airbag 5a disposed on the seat 5 in a state that the left arm of the user 200 is held on the armrest 6 by expanding the left arm airbag 6a. Thereby, the stretching effect can be obtained by twisting the lumbar of the user 200. In this case, it is possible to perform the stretching operation to twist the lumbar by expanding the right seat airbag 5b.

In addition, in the first practical example, the massager 100 may be constituted to perform the above stretching operation in a reclined posture that the backrest 2 is reclined in laying down direction. When the stretching operation is performed under such a state, the stretching effect becomes much higher. In addition, when the airbags 3a to 5b on the shoulder portion 3, the lumbar portion 4 and the seat 5 are serially expanded and shrunk with upsetting the timing, the stretching operation can be performed effectively without tiring the user 200.

### SECOND PRACTICAL EXAMPLE

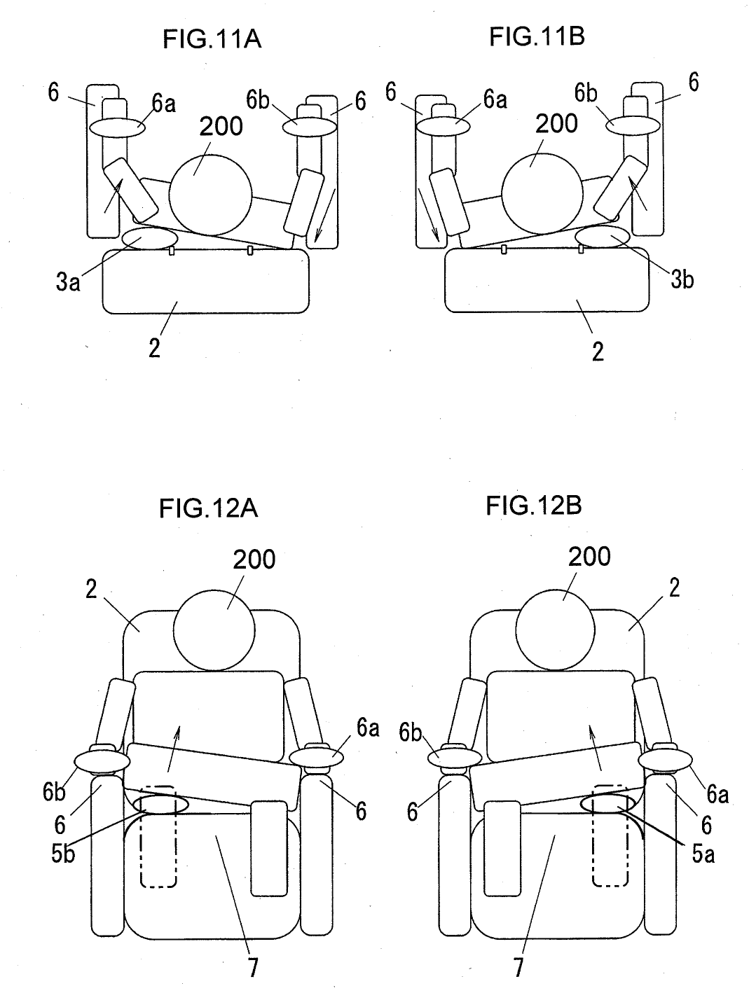

Motion of the massager 100 in a stretching operation in accordance with a second practical example is described with reference to FIGS. 9 to 12. In the second practical example, the stretching operation is performed by expanding and shrinking one or both of the left and right airbags 3a to 5b in the shoulder portion 3 or the lumbar portion 4 or the seat 5 or alternately expanding and shrinking left and right of these airbags 3a to 5b in a state that both arms of the user 200 are held on the armrests 6 by expanding both of the arm airbags 6a and 6b. As shown in FIG. 9, for example, the massager 100 holds both arms of the user 200 by expanding the arm airbags 6a and 6b. Then, the left shoulder airbag 3a is expanded to break down the left-and-right balance of the human body of the user. Thereby, the hack of the user 200 becomes a twisted state, and thus, the stretch effect can be obtained. In this case, it is possible to expand the left lumbar airbag 4a to perform the stretching operation. Alternatively, as shown in FIG. 10, for example, the massager 100 performs the stretching operation by pressing both shoulders of the user 200 by expanding both of the left and right shoulder airbags 3a and 3b in a state that both arms of the user are held on the armrest 6. In this case, it is possible to perform the stretching operation by pressing the lumbar of the user 200 by expanding the left and right lumbar airbags 4a and 4b. Alternatively, as shown in FIG. 11A and FIG. 11B, for example, the massager 100 continuously performs the stretching operation to twist the back alternately by braking down the left-and-right balance of the human body of the user 200 by alternately expanding the shoulder airbags 3a and 3b in a state that both arms of the user 200 are held on the armrests 6. Alternatively, as shown in FIG. 12A and FIG. 12B, for example, the massager 100 continuously performs the stretching operation to twist the back alternately by braking down the left-and-right balance of the human body of the user 200 by alternately expanding the seat airbags 5a and 5b in a state that both arms of the user 200 are held on the armrests 6.

Besides, in the second practical example, by performing the stretching operation in a reclined posture that the backrest 2 is reclined in laying down direction, the stretching effect becomes much higher, similar to the above example. In addition, when the airbags 3a to 5b on the shoulder portion 3, the lumbar portion 4 and the seat 5 are serially expanded and shrunk with upsetting the timing, the stretching operation can be performed effectively without tiring the user 200.

### THIRD PRACTICAL EXAMPLE

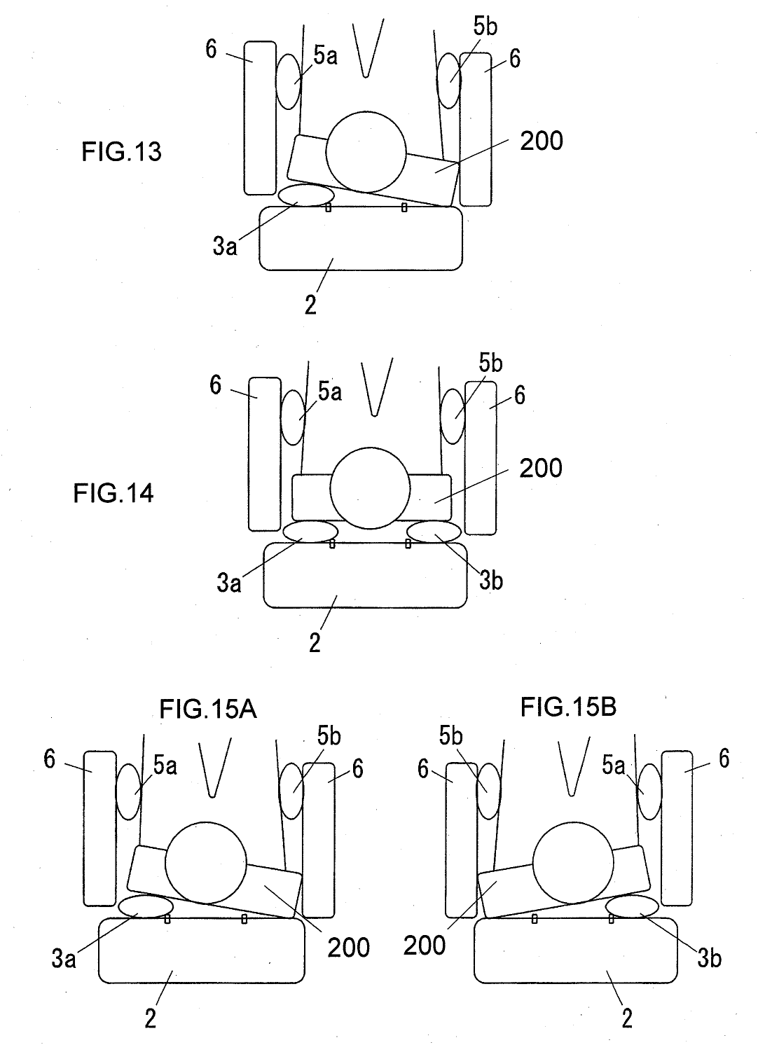

Motion of the massager 100 in a stretching operation in accordance with a third practical example is described with reference to FIGS. 13 to 15. In the third practical example, the stretching operation is performed by expanding and shrinking one or both of the airbags 3a to 4b in the shoulder portion 3 or the lumbar portion 4 or alternately expanding and shrinking left and right of these airbags 3a to 4b in a state that hip of the user 200 is held on the seat 5 by expanding both of the seat airbags 5a and 5b. As shown in FIG. 13, for example, the massager 100 holds the hip of the user 200 by expanding the seat airbags 5a and 5b. Then, the left shoulder airbag 3a is expanded to break down the balance of the human body of the user in the left and right direction. Thereby, the hack of the user 200 becomes a twisted state, and thus, the stretch effect can be obtained. In this case, it is possible to expand the left lumbar airbag 4a to perform the stretching operation. Alternatively, as shown in FIG. 14, for example, the massager 100 performs the stretching operation by pressing both shoulders of the user 200 by expanding both of the left and right shoulder airbags 3a and 3b in a state that the hip of the user 200 is held on the seat 5. In this case, it is possible to perform the stretching operation by pressing the lumbar of the user 200 by expanding the left and right lumbar airbags 4a and 4b. Alternatively, as shown in FIG. 15A and FIG. 15B, for example, the massager 100 continuously performs the stretching operation to twist the back alternately by braking down the left-and-right balance of the human body of the user 200 by alternately expanding the left and right shoulder airbags 3a and 3b in a state that the hip of the user 200 is held on the seat 5. In this case, it is possible to perform the stretching operation by alternately expanding and shrinking the left and right lumbar airbags 4a and 4b.

Besides, in the third practical example, by performing the stretching operation in a reclined posture that the backrest 2 is reclined in laying down direction, the stretching effect becomes much higher, similar to the above example. In addition, when the airbags 3a to 4b in the shoulder portion 3 or the lumbar portion 4 are serially expanded and shrunk with upsetting the timing, the stretching operation can be performed effectively without tiring the user 200.

### FOURTH PRACTICAL EXAMPLE

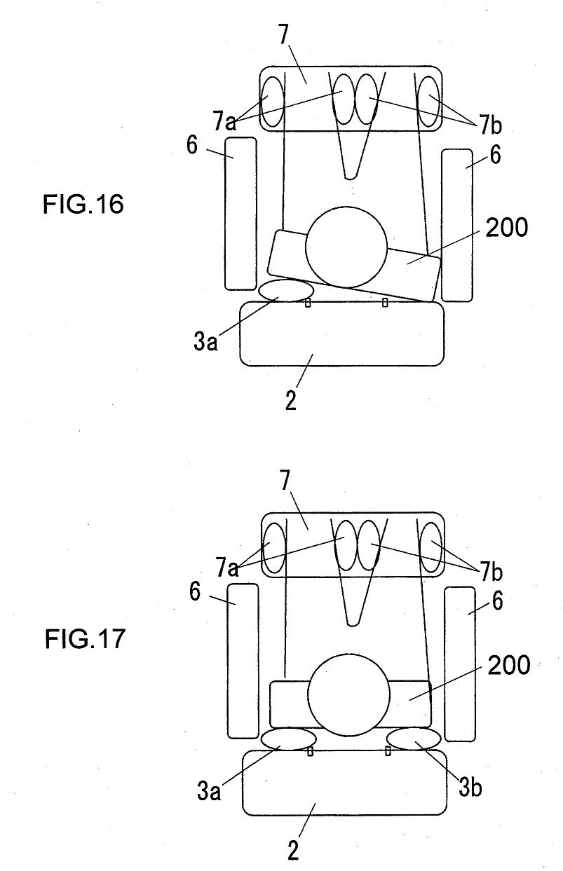

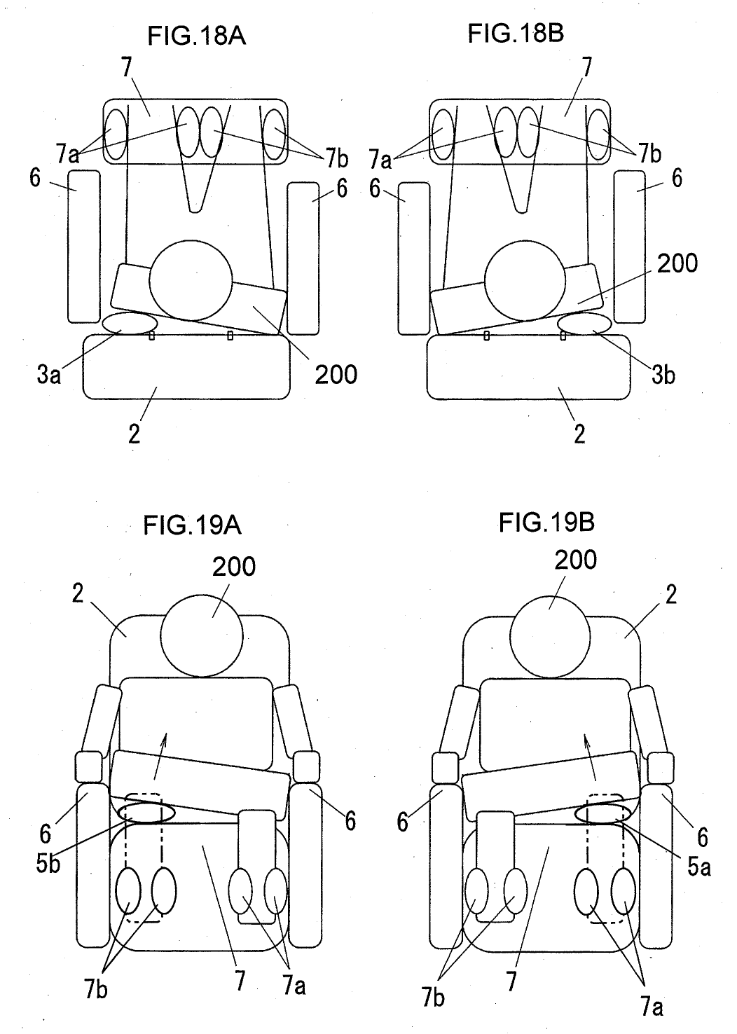

Motion of the massager 100 in a stretching operation in accordance with a fourth practical example is described with reference to FIGS. 16 to 19. In the fourth practical example, the massager 100 performs the stretching operation by expanding and shrinking one or both of the airbags 3a to 5b in the shoulder portion 3 or the lumbar portion 4 or the seat 5 or alternately expanding and shrinking left and right of these airbags 3a to 5b in a state that calves which are portions of legs of the user 200 are held on the leg-rest 7 by expanding both of the leg airbags 7a and 7b. As shown in FIG. 16, for example, the massager 100 holds the calves of the user 200 by expanding the leg airbags 7a and 7b. Then, the left shoulder airbag 3a is expanded to break down the left-and-right balance of the human body of the user 200. Thereby, the hack of the user 200 becomes a twisted state, and thus, the stretch effect can be obtained. In this case, it is possible to expand the left lumbar airbag 4a to perform the stretching operation. Alternatively, as shown in FIG. 17, for example, the massager 100 in the fourth practical example performs the stretching operation by pressing both shoulders of the user 200 by expanding both of the left and right shoulder airbags 3a and 3b in a state that the calves of the user 200 are held on the leg-rest 7. In this case, it is possible to perform the stretching operation by pressing the lumbar of the user 200 by expanding the left and right lumbar airbags 4a and 4b. Alternatively, as shown in FIG. 18A and FIG. 18B, for example, the massager 100 continuously performs the stretching operation to twist the back alternately by braking down the left-and-right balance of the human body of the user 200 by alternately expanding the shoulder airbags 3a and 3b in a state that the calves of the user 200 are held on the leg-rest 7. In this case, it is possible to perform the stretching operation by alternately expanding and shrinking the left and right lumbar airbags 4a and 4b. In addition, as shown in FIG. 19A and FIG. 19B, it is possible to perform the stretching operation alternately to twist the lumbar of the user 200 by alternately expanding and shrinking the seat airbags 5a and 5b. Since the lumbar is twisted while the legs of the user 200 are held, stretching effect becomes much higher.

Besides, in the fourth practical example, it is possible to hold the calves and feet of the user 200 on the leg-rest 7 by expanding the foot airbags 7c and 7d too, if necessary. Thereby, the legs of the user 200 can be held firmly so that effective stretching operation can be performed surely. In addition, when performing the stretching operation in a reclined posture that the backrest 2 is reclined in laying down direction, the stretching effect becomes much higher, similar to the above example. In addition, when the airbags 3a to 4b in the shoulder portion 3 or the lumbar portion 4 are serially expanded and shrunk with upsetting the timing, the stretching operation can be performed effectively without tiring the user 200.

### FIFTH PRACTICAL EXAMPLE

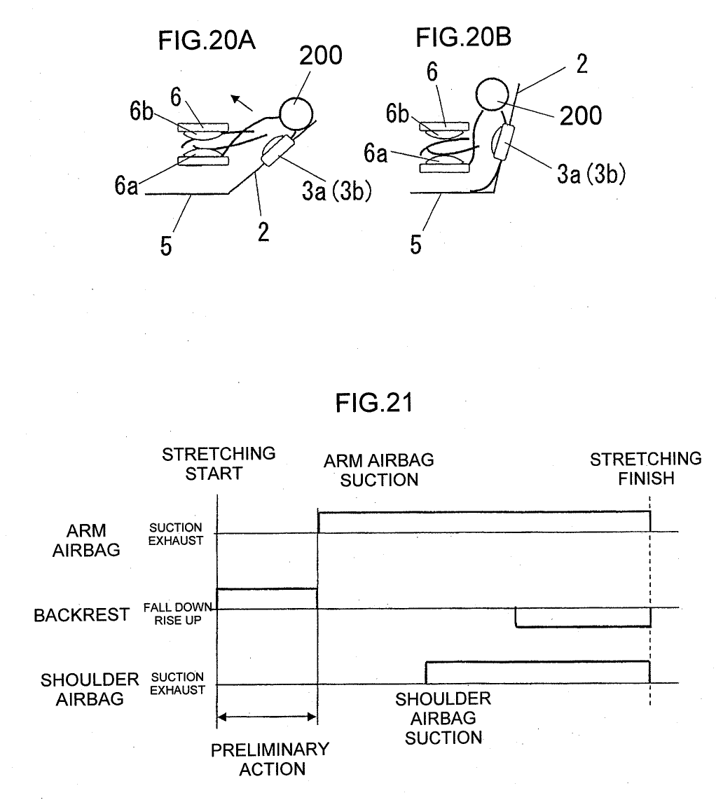

Motion of the massager 100 in a stretching operation in accordance with a fifth practical example is described with reference to FIG. 20A, FIG. 20B and FIG. 21. In the fifth practical example, when starting the stretching operation, as shown in FIG. 21, for example, the massager 100 reclines the backrest 2 as a preliminary action by the backrest reclining mechanism 16 first, so that a reclining angle of the backrest 2 with respect to the seat 5 is set to be a predetermined initial reclining angle. Subsequently, as shown in FIG. 20A, both of the arm airbags 6a and 6b are expanded to hold both arms of the user 200 on the armrests 6. Then, while keeping the expanded state of the arm airbags 6a and 6b, the shoulder airbags 3a and 3b are expanded to press the back of the user 200. FIG. 20A and FIG. 20B illustrate only the shoulder airbag 3a and illustration of another shoulder airbag 3b is omitted. After that, the massager 100 raises up the backrest 2 by the backrest reclining mechanism 16 while keeping the expansion of the arm airbags 6a and 6b and the shoulder airbags 3a and 3b, as shown in FIG. 20B. Thereby, the stretching of the shoulder and so on of the user 200 can be performed effectively.

In the fifth practical example, it is possible to perform the stretching operation with holding an arm of the user 200 by expanding one of the arm airbags 6a and 6b. In addition, it is possible to press the user 200 by expanding the lumbar airbags 4a and 4b or the seat airbags 5a and 5b instead of the shoulder airbags 3a and 3b, or to perform the stretching operation by expanding a plurality of airbags 3a to 4b on the shoulder portion 3, the lumbar portion 4 and so on. In addition, when the airbags 3a to 4b on the shoulder portion 3 or the lumbar portion 4 are serially expanded and shrunk with upsetting the timing, the stretching operation can be performed effectively without tiring the user 200.

### SIXTH PRACTICAL EXAMPLE

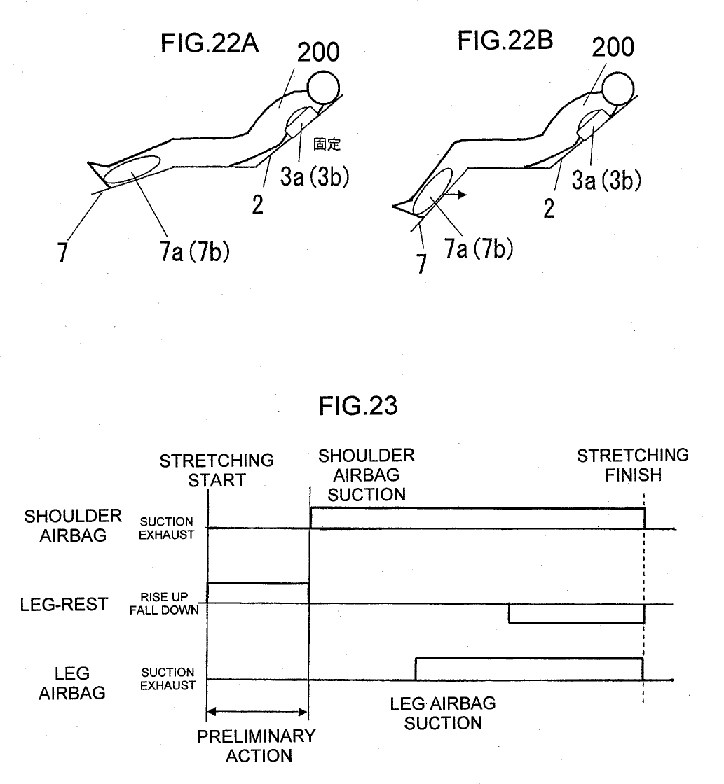

Motion of the massager 100 in a stretching operation in accordance with a sixth practical example is described with reference to FIG. 22A, FIG. 22B and FIG. 23. In the sixth practical example, when starting the stretching operation, as shown in FIG. 23, for example, the massager 100 displaces the leg-rest 7 to rise up the feet portion as a preliminary action by the leg-rest reclining mechanism 17, so that a reclining angle of the leg-rest 7 with respect to the seat 5 is set to be a predetermined initial reclining angle. Subsequently, as shown in FIG. 22A, both of the shoulder airbags 3a and 3b are expanded to hold the back of the user 200 on the backrest 2. Then, in such state, both of the leg airbags 7a and 7b are expanded to hold the calves of the user 200 on the leg-rest 7. After that, the massager 100 varies the reclining angle of the leg-rest 7 with respect to the seat 5 by the leg-rest reclining mechanism 17 so as to sink down the feet portion of the leg-rest 7 while keeping the expansion of the shoulder airbags 3a and 3b and the leg airbags 7a and 7b, as shown in FIG. 22B. Thereby, the stretching of the lumbar or legs and so on of the user 200 can be performed effectively. In addition, it is possible to perform the stretching operation by expanding the lumber airbags 4a and 4b to hold the lumber of the user 200 instead of the shoulder airbags 3a and 3b.

In the sixth practical example, it is possible to obtain stretching effect much higher by performing the above mentioned stretching operation in a reclined posture that the backrest 2 is reclined in laying down direction, similar to the above mentioned examples. In addition, it is possible to hold the calves and feet of the user 200 on the leg-rest 7 by expanding the foot airbags 7c and 7d too, if necessary. In the sixth practical example, the stretching effect can be obtained by utilizing the leg-rest reclining mechanism 17 in a state of holding the feet and back of the user 200.

### Other Modification

The present invention is not limited to the configurations of the above mentioned practical examples, and various modifications are enabled in a scope where the gist of the invention is not changed. For example, in each practical example, the combination of the airbags which are expanded and shrunk in the stretching operation is not limited to the above, so that the stretching operation can be performed in various manners.

A massager in accordance with the present invention is a chair type massager comprising a backrest, a seat and armrests disposed at both side of the seat, airbags that perform air-massage by expansion and shrinkage provided at both side of one or more portions among a shoulder portion or a lumbar portion of the backrest and the seat, and arm airbags that perform air-massage by expansion and shrinkage respectively provided on left and right armrests. The massager performs a stretching operation by expanding and shrinking one or both of the airbags provided at both side of one or more portions among the shoulder portion or the lumbar portion of the backrest and the seat, or alternately expanding and shrinking the airbags in a state that an arm of the user is held on the armrest by expanding the arm airbag provided on at least one armrest.

Alternatively, the above mentioned massager is a chair type massager comprising a backrest and a seat, airbags that perform air-massage by expansion and shrinkage provided at both side of one or more portions among a shoulder portion or a lumbar portion of the backrest, and airbags that can hold hip of a user by expansion and shrinkage provided on the seat. The massager preferably performs a stretching operation by expanding and shrinking one or both of the airbags provided at both side of one or more portions among the shoulder portion or the lumbar portion of the backrest, or alternately expanding and shrinking the airbags in a state that the hip of the user is held on the seat by expanding the airbags provided on the seat.

Alternatively, the above mentioned massager is a chair type massager comprising a backrest, a seat and a leg-rest which is provided in front of the seat, airbags that perform air-massage by expansion and shrinkage provided at both side of one or more portions among a shoulder portion or a lumbar portion of the backrest or the seat, and leg airbags that perform air-massage by expansion and shrinkage provided on the leg-rest. The massager preferably performs a stretching operation by expanding and shrinking one or both of the airbags provided at both side of one or more portions among the shoulder portion or the lumbar portion of the backrest or the seat, or alternately expanding and shrinking the airbags in a state that legs of the user are held on the leg-rest by expanding the leg airbags.

Alternatively, the above mentioned massager is a chair type massager comprising a backrest, a seat, armrests disposed at both sides of the seat, and a backrest reclining mechanism which holds the backrest with respect to the seat enabling to rise up or fall down, airbags that perform air-massage by expansion and shrinkage provided at both side of one or more portions among a shoulder portion or a lumbar portion of the backrest or the seat, and arm airbags that perform air-massage by expansion and shrinkage provided on the armrests. The massager preferably performs a stretching operation by setting an angle of the backrest with respect to the seat to be a predetermined initial reclining angle by the backrest reclining mechanism, and expanding and shrinking the airbags provided at both side of one or more portions among the shoulder portion or the lumbar portion of the backrest or the seat in a state that one or both arms of the user are held on the armrests by expanding one or both arm airbags on the armrests, and after that, raising up the backrest by the backrest reclining mechanism.

Alternatively, the above mentioned massager is a chair type massager comprising a backrest, a seat, a leg-rest which is provided in front of the seat, and a leg-rest reclining mechanism which holds the leg-rest with respect to the seat enabling to rise up or fall down, airbags that perform air-massage by expansion and shrinkage provided at both side of one or more portions among a shoulder portion or a lumbar portion of the backrest, and leg airbags that perform air-massage by expansion and shrinkage provided on the leg-rest. The massager preferably performs a stretching operation so that by setting an angle of the leg-rest with respect to the seat to be a predetermined initial reclining angle by the leg-rest reclining mechanism, holding shoulder or lumbar of the user or holding the shoulder and the lumbar of the user on the backrest by expanding and shrinking the airbags provided at both side of one or more portions among the shoulder portion or the lumbar portion of the backrest, and holding the legs of the user on the leg-rest by expanding the leg airbags, and after that, changing the reclining angle of the leg-rest with respect to the seat to fall down the leg-rest by the leg-rest reclining mechanism.

In the massager in accordance with the present invention, a part of the airbags are expanded so as to hold a portion of a human body of a user on a main body of the massager, and other airbags are expanded and shrunk so as to break down the left-and-right balance of the human body, so that stretching operation with larger stretching effect can be performed. Alternatively, a part of the airbags are expanded so as to hold a portion of a human body of a user on a main body of the massager, and other airbags are expanded and shrunk so as to press the human body of the user, so that stretching operation with larger stretching effect can be performed. In addition, the stretching operation is performed with using the backrest reclining mechanism or the leg-rest reclining mechanism, the stretching effect much larger can be obtained.

This application is based on Japanese patent application 2006-089577 filed in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A chair massager comprising a backrest, a seat and armrests disposed at both side of the seat,
airbags that perform air-massage by expansion and shrinkage provided at both side of one or more portions among a shoulder portion or a lumbar portion of the backrest and the seat, and
arm airbags that perform air-massage by expansion and shrinkage respectively provided on left and right armrests, wherein
the massager performs a stretching operation by expanding and shrinking one or both of the airbags provided at both side of one or more portions among the shoulder portion or the lumbar portion of the backrest and the seat, or alternately expanding and shrinking the airbags in a state that an arm of the user is held on the armrest by expanding the arm airbag provided on at least one armrest.

2. A chair massager comprising a backrest and a seat,
airbags that perform air-massage by expansion and shrinkage provided at both side of at least one portion or a plurality of portions among shoulder portion or lumbar portion of the backrest, and
airbags that can hold hip of a user by expansion and shrinkage provided on the seat, wherein
the massager performs a stretching operation by expanding and shrinking one or both of the airbags provided at both side of one or more portions among the shoulder portion or the lumbar portion of the backrest, or alternately expanding and shrinking the airbags in a state that the hip of the user is held on the seat by expanding the airbags provided on the seat.

3. A chair massager comprising a backrest, a seat and a leg-rest which is provided in front of the seat,
airbags that perform air-massage by expansion and shrinkage provided at both side of one or more portions among a shoulder portion or a lumbar portion of the backrest or the seat, and
leg airbags that perform air-massage by expansion and shrinkage provided on the leg-rest, wherein
the massager performs a stretching operation by expanding and shrinking one or both of the airbags provided at both side of one or more portions among the shoulder portion or the lumbar portion of the backrest or the seat, or alternately expanding and shrinking the airbags in a state that legs of the user are held on the leg-rest by expanding the leg airbags.

4. A chair massager comprising a backrest, a seat, armrests disposed at both sides of the seat, and a backrest reclining mechanism which holds the backrest with respect to the seat enabling to rise up or fall down,
airbags that perform air-massage by expansion and shrinkage provided at both side of one or more portions among a shoulder portion or a lumbar portion of the backrest or the seat, and
arm airbags that perform air-massage by expansion and shrinkage provided on the armrests, wherein
the massager preferably performs a stretching operation by setting an angle of the backrest with respect to the seat to be a predetermined initial reclining angle by the backrest reclining mechanism, and expanding and shrinking the airbags provided at both side of one or more portions among the shoulder portion or the lumbar portion of the backrest or the seat in a state that one or both arms of the user are held on the armrests by expanding one or both arm airbags on the armrests, and after that, raising up the backrest by the backrest reclining mechanism.

5. A chair massager comprising a backrest, a seat, a leg-rest which is provided in front of the seat, and a leg-rest reclining mechanism which holds the leg-rest with respect to the seat enabling to rise up or fall down,
airbags that perform air-massage by expansion and shrinkage provided at both side of one or more portions among a shoulder portion or a lumbar portion of the backrest, and
leg airbags that perform air-massage by expansion and shrinkage provided on the leg-rest, wherein
the massager performs a stretching operation so that by setting an angle of the leg-rest with respect to the seat to be a predetermined initial reclining angle by the leg-rest reclining mechanism, holding shoulder or lumbar of the user or holding the shoulder and the lumbar of the user on the backrest by expanding and shrinking the airbags provided at both side of one or more portions among the shoulder portion or the lumbar portion of the backrest, and holding the legs of the user on the leg-rest by expanding the leg airbags, and after that, changing the reclining angle of the leg-rest with respect to the seat to fall down the leg-rest by the leg-rest reclining mechanism.
